(19) United States
(12) Patent Application Publication
(10) Pub. No.: US 2025/0276934 A1
(43) Pub. Date: Sep. 4, 2025

(54) PHOTOSENSITIVE GLASS

(71) Applicant: AGC Inc., Tokyo (JP)

(72) Inventors: Shota ICHIKAWA, Shizuoka (JP); Nobuo INUZUKA, Shizuoka (JP); Makoto SHIRATORI, Shizuoka (JP)

(73) Assignee: AGC Inc., Tokyo (JP)

(21) Appl. No.: 19/064,890

(22) Filed: Feb. 27, 2025

(30) Foreign Application Priority Data
Mar. 1, 2024 (JP) 2024-031547
Feb. 19, 2025 (JP) 2025-025261

(51) Int. Cl. C03C 4/04; C03C 3/095; C03C 23/00

(52) U.S. Cl. CPC C03C 4/04; C03C 3/095; C03C 23/002; C03C 23/007

(57) ABSTRACT

The present invention relates to a photosensitive glass, in which in a case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid, when an colloid absorbance at an ultraviolet exposure dose of 0 J/cm², 1 J/cm², and 2 J/cm² is plotted on a coordinate system with the ultraviolet exposure dose (J/cm²) on a horizontal axis and the colloid absorbance (mm⁻¹) on a vertical axis, (slope at ultraviolet exposure dose of 1 J/cm² to 2 J/cm²)/(slope at ultraviolet exposure dose of 0 J/cm² to 1 J/cm²) is greater than 1.0.

### CROSS-REFERENCE TO RELATED APPLICATIONS

This application is based on and claims priority under 35 USC 119 from Japanese Patent Applications No. 2024-031547 filed on Mar. 1, 2024 and No. 2025-025261 filed on Feb. 19, 2025, the contents of which are incorporated herein by reference.

### TECHNICAL FIELD

The present invention relates to a photosensitive glass.

### BACKGROUND ART

A photosensitive glass is a glass in which a glass structure of an exposed portion changes by combining light irradiation and a heat treatment and is a glass in which only the exposed portion can be selectively crystallized. Specifically, when heat is applied to a photosensitive glass that has been exposed to radiation of short wavelength such as ultraviolet light, a Ag colloid is formed in the exposed portion, and the Ag colloid acts as a nucleus to precipitate fine crystals, which can change a color, a refractive index, chemical durability, and glass strength of the exposed portion (for example, Patent Literature 1).

Patent Literature 1: JP2017-36200A

### SUMMARY OF INVENTION

In the case of performing a predetermined pattern processing on the photosensitive glass, the photosensitive glass may be exposed to light through a mask 2 having openings 4, as shown in FIG. 1. In this case, when emitted light 3 passes through the openings 4, diffracted light 5 and stray light 6 are generated. An exposure dose from the diffracted light 5 and the stray light 6 is small, but when sensitivity due to the exposure is high, crystals are precipitated in the photosensitive glass. Therefore, in such a case, there is a possibility that crystals are precipitated in portions other than a target portion. In addition, when a diameter of the openings 4 in the mask 2 is small, a diffraction angle is larger. Therefore, a crystal precipitation diameter on a back surface side of a photosensitive glass 1 opposite to the exposed surface is even larger.

In this way, in the case where the photosensitive glass is exposed to a light through a mask having openings, there is a risk that diffracted light and stray light cause crystals to precipitate in positions other than an intended position, and when the crystals are dissolved by etching, there is a problem that an intended structure is not obtained.

Therefore, an object of the present invention is to provide a photosensitive glass that enables precise pattern processing by preventing crystal precipitation caused by diffracted light and stray light in the case where the photosensitive glass is exposed to a light through a mask having openings.

An aspect of the present invention relate to a photosensitive glass, in which in a case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid, when an colloid absorbance at an ultraviolet exposure dose of 0 J/cm², 1 J/cm², and 2 J/cm² is plotted on a coordinate system with the ultraviolet exposure dose (J/cm²) on a horizontal axis and the colloid absorbance (mm⁻¹) on a vertical axis, (slope at ultraviolet exposure dose of 1 J/cm² to 2 J/cm²)/(slope at ultraviolet exposure dose of 0 J/cm² to 1 J/cm²) is greater than 1.0. Hereinafter, the “(slope at ultraviolet exposure dose of 1 J/cm² to 2 J/cm²)/(slope at ultraviolet exposure dose of 0 J/cm² to 1 J/cm²)” may be referred to as “this index”.

According to the aspect of the present invention, it is possible to provide a photosensitive glass that enables precise pattern processing by preventing crystal precipitation caused by diffracted light and stray light in the case where the photosensitive glass is exposed to a light through a mask having openings.

### BRIEF DESCRIPTION OF DRAWINGS

FIG. 1 is a conceptual diagram illustrating a state where diffracted light 5 and stray light 6 are generated in the case where a photosensitive glass 1 is irradiated with light 3 through a mask 2 having openings 4.

FIG. 2 is a graph in which data of photosensitive glasses in Example 1 and Example 2 are plotted on a coordinate system with an ultraviolet exposure dose (J/cm²) on a horizontal axis and a colloid absorbance (mm⁻¹) on a vertical axis.

FIG. 3 shows a microscope photograph of a glass surface after patterning of each of the photosensitive glasses in Example 1 and Example 2.

FIG. 4 is a graph in which data of photosensitive glasses in Examples 1 to 23 are plotted on a coordinate system with Sb₂O₃/CeO₂ on a horizontal axis and this index on a vertical axis.

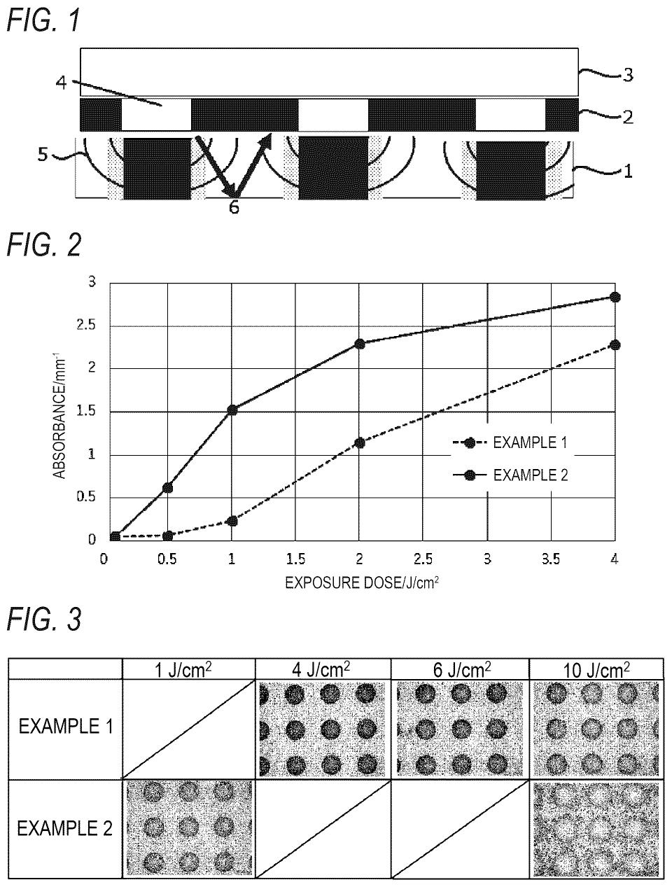

### DESCRIPTION OF EMBODIMENTS

Hereinafter, the present invention is described in detail, but the present invention is not limited to the following embodiments, and can be freely modified and implemented without departing from the gist of the present invention.

In the present description, “to” indicating a numerical range is used in the sense of including the numerical values set forth before and after the “to” as a lower limit value and an upper limit value, unless otherwise specified.

In the present description, a “photosensitive glass” refers to a glass in which a metal colloid is generated in the glass and crystals are further precipitated by an exposure and a heat treatment. More specifically, in the “photosensitive glass”, as shown in the following formulas, a trivalent Ce ion releases an electron upon exposure, the released electron is trapped by a Ag ion, followed by generating a silver atom.

Ce³⁺→Ce⁴⁺+e⁻

Ag⁺+e⁻→Ag

Thereafter, the photosensitive glass is subjected to a heat treatment to generate a silver colloid, and by further raising the temperature and performing a heat treatment, crystals are precipitated with the silver colloid as a nucleus.

Examples of a photosensitive glass according to one embodiment of the present invention include a photosensitive glass in which a NaF crystal is precipitated as a main crystal by an exposure and a heat treatment. Since the refractive index of the glass changes in a region where the NaF crystal is precipitated, such a glass can be suitably used, for example, in a volume holographic grating. In the present description, the “main crystal” means a crystal that precipitates in the largest amount among crystals precipitated by an exposure and a heat treatment.

In the present description, a photosensitive glass in which a NaF crystal is precipitated as a main crystal by an exposure and a heat treatment may be referred to as a “refractive index variable type glass”.

In the refractive index variable type glass, a crystal is precipitated in an exposed portion due to optical interference, and the glass containing precipitated crystal functions as a diffraction grating. If the crystal precipitation is non-uniform, there is a possibility that unity of light is impaired, but if the crystal is precipitated with precision, the light can be extracted more uniformly, resulting in higher unity of the light. The precise pattern processing can be performed on the photosensitive glass according to the embodiment of the present invention, and therefore the photosensitive glass according to the embodiment of the present invention also suitable for use as the “refractive index variable type glass”.

Examples of a photosensitive glass according to another embodiment of the present invention include a photosensitive glass in which a lithium silicate crystal such as a Li₂SiO₃ crystal or a Li₂Si₂O₅ crystal is precipitated as a main crystal by an exposure and a heat treatment. Since the crystal of the photosensitive glass in which the lithium silicate crystal is precipitated has a very high solubility in HF, the exposed portion can be selectively removed by HF etching, thereby forming fine patterns.

In the present description, a photosensitive glass in which a lithium silicate crystal is precipitated as a main crystal by an exposure and a heat treatment may be referred to as a “microfabrication type glass”.

The precise pattern processing can be performed on the photosensitive glass according to the embodiment of the present invention, and therefore the photosensitive glass according to the embodiment of the present invention is also suitable for use as the “microfabrication type glass”.

In the present description, a “photosensitive glass according to the present embodiment” includes both the refractive index variable type glass and the microfabrication type glass.

The above NaF crystal and lithium silicate crystal can be identified by, for example, X-ray diffraction measurement (XRD). Specifically, they are identified by measurement by XRD using CuKα rays at 2θ=10° to 90° and comparing the obtained plurality of diffraction peaks with a Cambridge structural database (CSD) or inorganic crystal structure database (ICSD).

### Photosensitive Glass

In the photosensitive glass according to the embodiment of the present invention (hereinafter, also referred to as the photosensitive glass according to the present embodiment), in the case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid, when an colloid absorbance at an ultraviolet exposure dose of 0 J/cm², 1 J/cm², and 2 J/cm² is plotted on a coordinate system with the ultraviolet exposure dose (J/cm²) on a horizontal axis and the colloid absorbance (mm⁻¹) on a vertical axis, (slope at ultraviolet exposure dose of 1 J/cm² to 2 J/cm²)/(slope at ultraviolet exposure dose of 0 J/cm² to 1 J/cm²) is greater than 1.0.

The heat treatment at a temperature in a range of (a glass transition temperature Tg+20° C.) to (a glass transition temperature Tg+65° C.) means that Tg+20° C.≤T≤Tg+65° C., where T is a heat treatment temperature.

As described above, it is important that in the photosensitive glass according to the present embodiment, the (slope at ultraviolet exposure dose of 1 J/cm² to 2 J/cm²)/(slope at ultraviolet exposure dose of 0 J/cm² to 1 J/cm²) is greater than 1.0.

Here, the “slope at ultraviolet exposure dose of 1 J/cm² to 2 J/cm²” and the “slope at ultraviolet exposure dose of 0 J/cm² to 1 J/cm²” can be expressed by the following formulas, respectively, when the colloid absorbance at an ultraviolet exposure dose of 0 J/cm², 1 J/cm², and 2 J/cm² is plotted on the coordinate system with the ultraviolet exposure dose (J/cm²) on the horizontal axis and the colloid absorbance (mm⁻¹) on the vertical axis in the case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid.

Slope at ultraviolet exposure dose of 1 J/cm² to 2 J/cm² (slope of straight line connecting plot of colloid absorbance at ultraviolet exposure dose of 1 J/cm² and plot of colloid absorbance at ultraviolet exposure dose of 2 J/cm²)=(Abs2−Abs1)/(2 J/cm²⁻¹ J/cm²)

Slope at ultraviolet exposure dose of 0 J/cm² to 1 J/cm² (slope of straight line connecting plot of colloid absorbance at ultraviolet exposure dose of 0 J/cm² and plot of colloid absorbance at ultraviolet exposure dose of 1 J/cm²)=(Abs1−Abs0)/(1 J/cm²−0 J/cm²)

In the above formulas, “Abs2” means the colloid absorbance at an ultraviolet exposure dose of 2 J/cm², “Abs1” means the colloid absorbance at an ultraviolet exposure dose of 1 J/cm², and “Abs0” means the colloid absorbance at an ultraviolet exposure dose of 0 J/cm².

This index being greater than 1.0 means that a slope in a low ultraviolet exposure dose range of 0 J/cm² to 1 J/cm² is smaller than a slope in a high ultraviolet exposure dose range of 1 J/cm² to 2 J/cm². That is, this index being greater than 1.0 means that the absorbance is small at an exposure dose of equal to or smaller than a threshold value and that the absorbance is large at an exposure dose of equal to or greater than the threshold value, resulting in a photosensitive glass in which no crystals are generated at a low exposure level. On the other hand, when this index is 1.0 or less, a reaction during a low exposure is large, so that there is a concern that the crystal is generated at positions other than an intended position.

This index is preferably 1.5 or more, more preferably 2.0 or more, still more preferably 2.3 or more, particularly preferably 2.5 or more, and most preferably 2.8 or more, and may be 5.5 or less, 5.4 or less, 5.3 or less, or 5.2 or less. This index may be, for example, larger than 1.0 and 5.5 or less.

In the photosensitive glass according to the present embodiment, in order to make this index greater than 1.0, there can be mentioned a method of increasing the “slope at ultraviolet exposure dose of 1 J/cm² to 2 J/cm²”, which corresponds to the numerator of this index, or a method of decreasing the “slope at ultraviolet exposure dose of 0 J/cm² to 1 J/cm²”, which corresponds to the denominator of this index.

The “slope at ultraviolet exposure dose of 1 J/cm² to 2 J/cm²” being large means that a large amount of colloid is generated at an ultraviolet exposure dose of 1 J/cm² or more. The reason why the large amount of colloid is generated is large amount of reduction reaction to Ag. This is partly because of the large number of electrons released from Ce. The large number of electrons released from Ce means that the amount of Ce is large to a certain extent. Therefore, as to be described later, in the photosensitive glass according to the present embodiment, for example, by adjusting a lower limit of a content of Ce, the “slope at ultraviolet exposure dose of 1 J/cm² to 2 J/cm²” can be made larger.

The reason why the “slope at ultraviolet exposure dose of 0 J/cm² to 1 J/cm²” being small may be, for example, that amount of reduction reaction of Sb⁵⁺ occurring before Ag⁺ is large, or that the number of electrons that can be captured by Sb⁵⁺ is larger than the number of electrons released from Ce.

Regarding the reduction reaction of Sb⁵⁺ occurring before Ag⁺, the amount of Sb⁵⁺ depends on a charged amount and melting conditions. Therefore, as to be described later, in the photosensitive glass according to the present embodiment, for example, by adjusting a Sb₂O₃ content, the “slope at ultraviolet exposure dose of 0 J/cm² to 1 J/cm²” can be made smaller.

In addition, “the number of electrons that can be captured by Sb⁵⁺ is larger than the number of electrons released from Ce” means that the amount of Ce is not too large. Therefore, as to be described later, in the photosensitive glass according to the present embodiment, for example, by adjusting an upper limit of the content of Ce, the “slope at ultraviolet exposure dose of 0 J/cm² to 1 J/cm²” can be made smaller.

In order to irradiate the photosensitive glass with ultraviolet light having a wavelength of 300 nm to 330 nm, for example, a mask aligner (ES20ag manufactured by Nanometric Technology Inc.) can be used. A UV illuminance can be measured by attaching an ultraviolet cumulative photometer (UIT-250 manufactured by Ushio Inc.) and a light receiver (UVD-S313 manufactured by Ushio Inc.).

In order to perform the heat treatment for generating a colloid at a temperature in a range of (a glass transition temperature Tg+20° C.) to (a glass transition temperature Tg+65° C.) for 1 hour to 10 hours, for example, the heat treatment is performed by setting a temperature for a heating furnace and a heat treatment time within the above ranges.

The photosensitive glass according to the present embodiment preferably has a “slope at ultraviolet exposure dose of 0 J/cm² to 1 J/cm²” of 0.001 to 1.0 in this index. When the slope is 0.001 or more, a colloid is sufficiently generated after an exposure and a heat treatment. In addition, when the slope is 1.0 or less, the reaction during a low exposure is not too strong, and the crystal is less likely to generate at positions other than an intended position.

The slope is more preferably 0.005 or more, still more preferably 0.01 or more, still more preferably 0.03 or more, even more preferably 0.05 or more, still even more preferably 0.07 or more, and particularly preferably 0.115 or more, and is more preferably 0.7 or less, still more preferably 0.5 or less, even more preferably 0.3 or less, and particularly preferably 0.2 or less.

The photosensitive glass according to the present embodiment preferably has a ratio of a Sb₂O₃ content to a CeO₂ content, i.e., Sb₂O₃/CeO₂, of 3.0 to 20 in terms of mol % based on oxides.

Sb₂O₃ is a thermally reducible component and reduces metal ions during a heat treatment. In the photosensitive glass according to the present embodiment, Sb₂O₃ serves to reduce Ag ions in a high temperature range. In addition, in the photosensitive glass according to the present embodiment, CeO₂ also acts as a photosensitizer.

When the Sb₂O₃/CeO₂ is 3.0 or more, the Sb₂O₃ amount is sufficiently large relative to the CeO₂ amount, and a reaction under light at a low exposure is less likely to proceed. In addition, when the Sb₂O₃/CeO₂ is 20 or less, the amount of Ce as an electron donor material is not too small, the colloid is likely to generate after an exposure and a heat treatment, and the Sb₂O₃ amount relative to the CeO₂ amount is not too large, so that a high exposure dose provides sufficient photosensitivity.

The Sb₂O₃/CeO₂ is more preferably 5.0 or more, still more preferably 5.1 or more, even more preferably 5.3 or more, even still more preferably 5.5 or more, and particularly preferably 5.8 or more, and is more preferably 18 or less, still more preferably 16 or less, even more preferably 14 or less, even still more preferably 12 or less, and particularly preferably 10 or less.

The photosensitive glass according to the present embodiment preferably includes 0.01% to 0.3% of Sb₂O₃ in term of mol % based on oxides. When the photosensitive glass according to the present embodiment includes 0.01% or more of Sb₂O₃, metal ion reduction can be carried out stably during a heat treatment. In addition, when the photosensitive glass according to the present embodiment includes 0.3% or less of Sb₂O₃, coloring of the glass can be prevented.

In addition, when the photosensitive glass according to the present embodiment includes 0.01% to 0.3% of Sb₂O₃, the “slope at ultraviolet exposure dose of 0 J/cm² to 1 J/cm²” in this index can be made smaller, so that it is easy to make this index greater than 1.0. This is because the reduction reaction of Sb⁵⁺ occurring prior to Ag⁺ can be increased by adjusting the content of Sb₂O₃.

The photosensitive glass according to the present embodiment includes Sb₂O₃ in an amount of more preferably 0.04% or more, still more preferably 0.06% or more, and particularly preferably 0.08% or more, and more preferably 0.2% or less in term of mol % based on oxides.

The photosensitive glass according to the present embodiment preferably includes 0.002% to 0.04% of CeO₂ in term of mol % based on oxides. When the CeO₂ content is within the above range, the “slope at ultraviolet exposure dose of 1 J/cm² to 2 J/cm²” can be made larger and the “slope at ultraviolet exposure dose of 0 J/cm² to 1 J/cm²” can be made smaller in this index, so that it is easy to make this index greater than 1.0.

The “slope at ultraviolet exposure dose of 1 J/cm² to 2 J/cm²” being large means that a large amount of colloid is generated at an ultraviolet exposure dose of 1 J/cm² or more. The reason why the large amount of colloid is generated is large amount of reduction reaction to Ag. This is partly because of the large number of electrons released from Ce. The large number of electrons released from Ce means that the amount of Ce is large to a certain extent. Therefore, when the lower limit of the CeO₂ content is 0.002% or more, the “slope at ultraviolet exposure dose of 1 J/cm² to 2 J/cm²” can be made larger.

One of reasons why the “slope at ultraviolet exposure dose of 0 J/cm² to 1 J/cm²” is small is that the number of electrons that can be captured by Sb⁵⁺ is not excessively released from Ce. This means that the amount of Ce is not too large. Therefore, when the upper limit of the content of CeO₂ is 0.04% or less, the “slope at ultraviolet exposure dose of 0 J/cm² to 1 J/cm²” can be made smaller.

The photosensitive glass according to the present embodiment includes CeO₂ in an amount of more preferably 0.007% or more, still more preferably 0.008% or more, and particularly preferably 0.009% or more, and more preferably 0.03% or less, and still more preferably 0.025% or less in terms of mol % based on oxides.

The photosensitive glass according to the present embodiment may include B₂O₃. B₂O₃ is a component that forms a network structure in the glass. In addition, B₂O₃ contributes to improving dielectric properties such as a relative dielectric constant and a dielectric loss tangent in a high frequency range, and to improving solubility. When the photosensitive glass according to the present embodiment includes B₂O₃, the above effects can be expected.

The photosensitive glass according to the present embodiment preferably includes, in terms of mol % based on oxides,
59.0% to 81.0% of SiO₂,
8.0% to 26.0% of Li₂O,
1.0% to 10.0% of Na₂O,
1.0% to 10.0% of K₂O,
0% to 5.0% of Al₂O₃,
0% to 6.0% of ZnO, and
0% to 8.0% of B₂O₃.

Hereinafter, a preferred composition range of each component included in the photosensitive glass according to the present embodiment will be described.

SiO₂ is a component that forms a glass skeleton with a network structure, and that improves the acid resistance and the water resistance to stabilize the glass. It is also a component for forming and precipitating a Li₂SiO₃ crystal as a crystal phase in a microfabrication type glass. In the photosensitive glass according to the present embodiment, the content of SiO₂ is preferably 59.0% to 81.0%. When the content of SiO₂ is 59.0% or more, the glass is stabilized, and a precipitated crystal phase is easily stabilized when the photosensitive glass is crystallized. In the photosensitive glass according to the present embodiment, the content of SiO₂ is more preferably 61.0% or more, still more preferably 62.0% or more, even more preferably 63.0% or more, particularly preferably 64.0% or more, even still more preferably 65.0% or more, and most preferably 66.0% or more.

In addition, when the content of SiO₂ is 81.0% or less, it is easy to melt or mold the glass raw material. The content of SiO₂ is more preferably 78.0% or less, still more preferably 76.0% or less, even more preferably 75.0% or less, particularly preferably 74.0% or less, and most preferably 73.0% or less.

Li₂O is a component that lowers the viscosity of the glass and improves the meltability of the glass, but when it is added too much, a silica network structure is excessively fragmented and the stability of the glass is decreased. It is also a component for forming and precipitating a lithium silicate crystal such as a Li₂SiO₃ crystal and a Li₂Si₂O₅ crystal in the microfabrication type glass. The photosensitive glass according to the present embodiment preferably includes 8.0% to 26.0% of Li₂O. When the photosensitive glass according to the present embodiment includes Li₂O, a lithium silicate crystal is easily obtained, and the precipitated crystal phase is easily stabilized. The content of Li₂O is more preferably 10.0% or more, still more preferably 11.0% or more, even more preferably 12.0% or more, and particularly preferably 13.0% or more.

In addition, when the content of Li₂O is 26.0% or less, the stability of the glass is maintained. The content of Li₂O is more preferably 24.0% or less, still more preferably 23.0% or less, even more preferably 22.0% or less, particularly preferably 21.0% or less, and even still more preferably 20.0% or less.

Na₂O is a component that lowers the viscosity of the glass and improves the meltability of the glass, but when it is added too much, the silica network structure is excessively fragmented and the stability of the glass is decreased. It is also a component that contributes to decreasing a dielectric loss when added in mixture with Li₂O or K₂O. It is a component for forming and precipitating a NaF crystal in the refractive index variable type glass. In the photosensitive glass according to the present embodiment, the content of Na₂O is preferably 1.0% to 10.0%. When the photosensitive glass according to the present embodiment includes Na₂O, the meltability of the glass is improved, and in the coexistence with fluorine (F), the NaF crystal is easily obtained and the precipitated crystal phase is easily stabilized. The content of Na₂O is more preferably 2.0% or more, still more preferably 3.0% or more, even more preferably 4.0% or more, and particularly preferably 5.0% or more.

In addition, when the content of Na₂O is 10.0% or less, the stability of the glass is maintained, and the deterioration due to weathering can be prevented. The content of Na₂O is more preferably 9.0% or less, still more preferably 8.0% or less, and even more preferably 7.0% or less.

K₂O is a component that lowers the viscosity of the glass and improves the meltability of the glass, but when it is added too much, the silica network structure is excessively fragmented and the stability of the glass is decreased. It is also a component that contributes to decreasing the dielectric loss when added in mixture with Li₂O or Na₂O. In addition, it is a component that facilitates the precipitation of a Li₂SiO₃ crystal in a microfabrication type photosensitive glass. In the photosensitive glass according to the present embodiment, the content of K₂O is preferably 1.0% to 10.0%. When the photosensitive glass according to the present embodiment includes 1.0% or more of K₂), the meltability of the glass is improved. The content of K₂O is more preferably 2.0% or more, still more preferably 3.0% or more, and even more preferably 4.0% or more.

In addition, when the content of K₂O is 10.0% or less, the stability of the glass is maintained, and the deterioration due to weathering can be prevented. The content of K₂O is more preferably 9.0% or less, still more preferably 8.0% or less, and even more preferably 7.0% or less.

Al₂O₃ is a component that is effective in improving the acid resistance, increasing a Young's modulus, preventing phase separation of the glass, decreasing a coefficient of thermal expansion, and the like. In the photosensitive glass according to the present embodiment, the content of Al₂O₃ is preferably 0% to 5.0%. When Al₂O₃ is included, the stability of the glass is improved and the deterioration due to weathering is prevented. The content of Al₂O₃ is preferably 0% or more, and more preferably 0.5% or more, still more preferably 1.0% or more.

In addition, the content of Al₂O₃ is preferably 5.0% or less. When the content of Al₂O₃ is 5.0% or less, crystal precipitation from the glass can be maintained. The content of Al₂O₃ is more preferably 4.5% or less, still more preferably 4.0% or less, and even more preferably 3.5% or less.

ZnO is a component that increases the solubility of Ag₂O. In addition, ZnO may be effective in improving the chemical durability, preventing undesired reduction of silver, and the like. In the photosensitive glass according to the present embodiment, the content of ZnO is preferably 0% to 6.0%. When the photosensitive glass according to the present embodiment includes ZnO, only enough silver can be dissolved to develop sufficient photosensitivity for selective crystal precipitation. The content of ZnO is preferably 0% or more, more preferably 0.2% or more, particularly preferably 0.4% or more, still more preferably 0.6% or more, and most preferably 0.8% or more.

In addition, when the content of ZnO is 6.0% or less, a decrease in crystallization tendency can be prevented. The content of ZnO is more preferably 5.5% or less, still more preferably 5.0% or less, even more preferably 4.5% or less, particularly preferably 4.0% or less, even still more preferably 3.5% or less, and most preferably 3.0% or less.

B₂O₃ is a component that is effective in improving the acid resistance and decreasing the coefficient of thermal expansion. In the photosensitive glass according to the present embodiment, the content of B₂O₃ is preferably 0% to 8.0%. When the photosensitive glass according to the present embodiment includes B₂O₃, the stability of the glass is improved and the deterioration due to weathering can be prevented. In the microfabrication type glass, preventing etching of the glass has the effect of improving the pattern shape precision in etching. The content of B₂O₃ is preferably 0% or more, still more preferably 0.1% or more, even more preferably 0.2% or more, particularly preferably 0.3% or more, even still more preferably 0.4% or more, and most preferably 0.5% or more.

In addition, the content of B₂O₃ is preferably 8.0% or less. When the content of B₂O₃ is 8.0% or less, a variation in crystal precipitation properties due to phase separation can be prevented. The content of B₂O₃ is more preferably 7.0% or less, still more preferably 6.5% or less, and further still more preferably 6.0% or less.

The photosensitive glass according to the present embodiment may include SnO₂. Similar to Sb₂O₃, SnO₂ is a thermally reducible component and reduces metal ions during a heat treatment. In the present embodiment, SnO₂ serves to reduce Ag ions in a high temperature range. The coexistence of SnO₂ with Sb₂O₃ further improves a thermal reduction effect. When the photosensitive glass according to the present embodiment includes SnO₂, the formation of the Ag colloid is promoted by the heat treatment after the exposure.

In addition, when the content of SnO₂ is 1.0% or less, there is no risk that the function as a photosensitive glass is impaired, such as the reduction effect for metal ions being excessive and the Ag colloid being less likely to generate during melting. The content of SnO₂ is more preferably 0.8% or less, still more preferably 0.6% or less, even more preferably 0.4% or less, particularly preferably 0.3% or less, most preferably 0.2% or less, and further most preferably 0.1% or less.

The photosensitive glass according to the present embodiment preferably includes 0.01% to 1.0% of Ag₂O.

Ag₂O is a photosensitizer component that serves as a starting point of crystal growth to selectively crystallize the exposed portion, that is, a nucleus source. When the photosensitive glass according to the present embodiment includes 0.01% or more of Ag₂O, the exposed portion can be selectively crystallized. The content of Ag₂O is more preferably 0.015% or more, still more preferably 0.02% or more, even more preferably 0.022% or more, particularly preferably 0.025% or more, even still more preferably 0.027% or more, and most preferably 0.028% or more.

In addition, in the photosensitive glass according to the present embodiment, the content of Ag₂O is preferably 1.0% or less. When the content of Ag₂O is 1.0% or less, a melting residue of Ag₂O in the glass can be prevented. Further, a burden on melting equipment can be reduced. The content of Ag₂O is more preferably 0.9% or less, still more preferably 0.8% or less, even more preferably 0.7% or less, even still more preferably 0.6% or less, particularly preferably 0.5% or less, yet more preferably 0.4% or less, yet still more preferably 0.35% or less, and most preferably 0.3% or less.

It is preferable that the photosensitive glass according to the present embodiment is substantially free of Cr, Ni, V, Mn, and Co. That is, the content of Cr, Ni, V, Mn, and Co may be 5 ppm or less. This is because Cr, Ni, V, Mn, and Co are coloring components and have a problem of deteriorating a transmittance, particularly in the refractive index variable type glass. In addition, Cr, V, Mn, and Co, which are coloring components that absorb UV, may cause problems in the generation of the Ag colloid.

The photosensitive glass according to the present embodiment may include components other than the above components (hereinafter referred to as “other components”) within a range that does not impede the effects of the present invention. Examples of other components include Rb₂O, Cs₂O, MgO, CaO, SrO, BaO, P₂O₅, GeO₂, Sc₂O₃, Y₂O₃, La₂O₃, Pr₂O₃, Nd₂O₃, Pm₂O₃, Sm₂O₃, Eu₂O₃, Gd₂O₃, Tb₂O₃, Dy₂O₃, Ho₂O₃, TiO₂, Fe₂O₃, ZrO₂, Nb₂O₅, MoO₃, HfO₂, Ta₂O₃, and WO₃. The total content of these components is preferably 5% or less, more preferably 4% or less, still more preferably 3% or less, even more preferably 2% or less, particularly preferably 1% or less, even still more preferably 0.5% or less, and most preferably 0.1% or less.

The photosensitive glass according to the present embodiment preferably includes an ultraviolet absorbing component. This is because the photosensitive glass according to the present embodiment includes an ultraviolet absorbing component that inhibits ultraviolet absorption by Ce, thereby preventing the generation of the colloid. Examples of the ultraviolet absorbing component include Fe₂O₃ and TiO₂.

The photosensitive glass according to the present embodiment includes the ultraviolet absorbing component in an amount of preferably 0.001 mass % or more, more preferably 0.002 mass % or more, and still more preferably 0.003 mass % or more, and preferably 0.05 mass % or less, more preferably 0.04 mass % or less, still more preferably 0.03 mass % or less, and particularly preferably 0.02 mass % or less, from the viewpoint of maintaining the photosensitivity of the photosensitive glass.

### Method for Producing Photosensitive Glass

A method for producing the photosensitive glass according to the present embodiment is described by way of example. The method for producing the photosensitive glass according to the present embodiment includes heating a glass raw material containing a photosensitizer component to obtain a molten glass (melting step), molding the molten glass into a desired shape (molding step), and annealing the molded glass (annealing step)

Hereinafter, the steps are described.

The melting step is a step of heating a glass raw material containing a photosensitizer component to obtain a molten glass.

The photosensitizer component is a component capable of generating a nucleus serving as a starting point of crystal growth to selectively crystallize the exposed portion. Examples of the photosensitizer component include Ag₂O described above or Au₂O. Ag₂O is preferred because of having no absorption in a visible region, being easily dissolved in the glass, and having a raw material cost lower than that of Au₂O.

Examples of the glass raw material include a homogeneous mixture of a metal

oxide, a carbonate, a sulfate, a nitrate, glass cullet, or the like in the form of a powder or granules having appropriate particle size. The glass cullet is glass waste discharged during the glass production process.

A method for heating the glass raw material is not particularly limited, and examples thereof include a method in which the glass raw material is charged into a platinum crucible, and the platinum crucible is placed in an electric furnace, followed by heating and melting.

A melting temperature may be any temperature that can melt the glass raw material used, and may be, for example, 1400° C. to 1600° C., and preferably 1450° C. to 1550° C. In addition, a melting time may be, for example, 1 hour to 120 hours, and preferably 2 hours to 100 hours, depending on a melting scale (weight).

The molding step is a step of molding the molten glass obtained in the above melting step into a desired shape. The glass can be molded, for example, by pouring a molten glass into a preheated mold and solidifying the same into a desired shape. At this time, the glass can be molded into a plate shape, a tube shape, or the like by a down-draw method, a press method, or the like, or into a block shape, a column shape, or the like by billet molding or the like, or into a desired shape according to the use form using other molds.

The annealing step is a step of annealing the glass molded in the above molding step to room temperature.

In the present embodiment, in the annealing step, it is preferable to perform annealing at a cooling rate of 1° C./min or less from a temperature T1 to a temperature T2. Here, T1 is a temperature at an annealing point (Ap), and T2 is a temperature at a strain point (Sp).

When the annealing is performed at a cooling rate of 1° C./min or less from the temperature T1 to the temperature T2, a thermal strain inside the glass is removed and a variation in crystal precipitation can be prevented. The cooling rate from the temperature T1to the temperature T2 is more preferably 0.9° C./min or less, still more preferably 0.7° C./min or less, and particularly preferably 0.5° C./min or less.

From the viewpoint of preventing glass devitrification during the annealing, the cooling rate from the temperature T1 to the temperature T2 is preferably greater than 0.1° C./min, more preferably 0.15° C./min or more, and still more preferably 0.2° C./min or more.

In the production method according to the present embodiment, even in the case where the temperature T1 is changed from the annealing point (Ap), it is preferable that the cooling rate from the temperature T1 to the temperature T2 satisfies the above range. At this time, a range of change in temperature T1 may be a range from [annealing point (Ap)+30° C.] to [annealing point (Ap)−10° C.]. When the temperature is raised too much, there is a concern that the glass is crystallized.

In addition, in the production method according to the present embodiment, even in the case where the temperature T2 is changed from the strain point (Sp), it is preferable that the cooling rate from the temperature T1 to the temperature T2 satisfies the above range. At this time, a range of change in temperature T2 may be within a range lower than the strain point (Sp).

### Application

The photosensitive glass according to the present embodiment can form a processed pattern with good precision when subjected to an exposure and a heat treatment, and can thus be suitably used for an optical element and a substrate for microfabrication. Examples of the optical element include a volume holographic grating, and examples of the substrate for microfabrication include a circuit board for high frequency applications, and a substrate for microchannel devices.

Particularly, the refractive index variable type glass according to a specific aspect of the photosensitive glass according to the present embodiment can periodically change the refractive indexes of the exposed portion and the unexposed portion by two-beam interference exposure, and can be particularly preferably used as a volume holographic grating.

In addition, the microfabrication type glass according to another specific aspect of the photosensitive glass according to the present embodiment can form fine patterns such as a through glass via (TGV) and a cavity by drawing fine patterns all at once using mask exposure and performing etching after crystal precipitation, and can thus be particularly suitably used for a circuit board for high frequency applications and a substrate for microchannel devices.

As described above, the following configurations are disclosed in the present description.

1. A photosensitive glass, in which in a case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid, when an colloid absorbance at an ultraviolet exposure dose of 0 J/cm², 1 J/cm², and 2 J/cm² is plotted on a coordinate system with the ultraviolet exposure dose (J/cm²) on a horizontal axis and the colloid absorbance (mm⁻¹) on a vertical axis, (slope at ultraviolet exposure dose of 1 J/cm² to 2 J/cm²)/(slope at ultraviolet exposure dose of 0 J/cm² to 1 J/cm²) is greater than 1.0.

2. The photosensitive glass according to the above 1, in which the slope at ultraviolet exposure dose of 0 J/cm² to 1 J/cm² is 0.001 to 1.0.

3. The photosensitive glass according to the above 1 or 2, having a ratio of a Sb₂O₃ content to a CeO₂ content, that is Sb₂O₃/CeO₂, of 3.0 to 20 in terms of mol % based on oxides.

4. The photosensitive glass according to any one of the above 1 to 3, including: 0.01% to 0.3% of Sb₂O₃ in terms of mol % based on oxides.

5. The photosensitive glass according to any one of the above 1 to 4, including: 0.002% to 0.04% of CeO₂ in terms of mol % based on oxides.

6. The photosensitive glass according to any one of the above 1 to 5, including: B₂O₃.

7. The photosensitive glass according to any one of the above 1 to 5, including, in terms of mol % based on oxides, 59.0% to 81.0% of SiO₂, 8.0% to 26.0% of Li₂O, 1.0% to 10.0% of Na₂O, 1.0% to 10.0% of K₂O, 0% to 5.0% of Al₂O₃, 0% to 6.0% of ZnO, and 0% to 8.0% of B₂O₃.

8. The photosensitive glass according to any one of the above 1 to 7, including: 0.01% to 1.0% of Ag₂O in terms of mol % based on oxides.

9. The photosensitive glass according to any one of the above 1 to 8, including: an ultraviolet absorbing component.

### EXAMPLE

Hereinafter, the present invention is described with reference to Examples, but the present invention is not limited to these Examples. Examples 1, 3 to 7, 15, and 20 to 23 are Working Examples, and Examples 2, 8 to 14, and 16 to 19 are Comparative Examples.

### Preparation of Photosensitive Glass

### (Examples 1 to 23)

Glass cullet including SiO₂, Al(OH)₃, Na₂CO₃, NaF, NaBr, K₂CO₃, ZnO, CeO₂, SnO, Sb₂O₃, and Ag was used as a raw material, was charged into a platinum crucible, and then heated and melted at 1300° C. to 1550° C. for 24 hours with stirring. The homogeneously melted glass was poured into a cast iron mold, molded into a plate shape, and annealed to obtain a photosensitive glass in each example.

The content of each component in the photosensitive glass in each example is shown in Table 1 (mol %) and Table 2 (mass %).

### Exposure and Heat Treatment

The photosensitive glass in each example was exposed to ultraviolet light having a wavelength of 300 nm to 330 nm using a mask aligner (ES20ag manufactured by Nanometric Technology Inc.) at ultraviolet exposure doses of 0.5 J/cm², 1 J/cm², 2 J/cm², and 4 J/cm². The UV illuminance was measured by attaching an ultraviolet cumulative photometer (UIT-250 manufactured by Ushio Inc.) and a light receiver (UVD-S313 manufactured by Ushio Inc.).

Thereafter, a heat treatment was performed at the heat treatment temperature and time shown in Table 1 using a heat treatment furnace (UTO-15CD manufactured by KOYO THERMO SYSTEMS).

### Absorbance Measurement

The absorbance (mm⁻¹) of the colloid generated in the photosensitive glass in each example which had been exposed at the above ultraviolet exposure doses (J/cm²), followed by subjecting to the heat treatment was measured using a spectrophotometer (V-770manufactured by JASCO Corporation). Specifically, a maximum absorbance in an absorption band (400 nm to 500 nm) of the silver colloid generated in the glass was calculated using the above spectrophotometer in terms of 1 mm. In addition, the absorbance was similarly measured for a photosensitive glass that had not been subjected to an exposure or a heat treatment (ultraviolet exposure dose: 0 J/cm²).

Next, the colloid absorbances at ultraviolet exposure doses of 0 J/cm², 0.5 J/cm², 1 J/cm², 2 J/cm², and 4 J/cm² were plotted on a coordinate system with the ultraviolet exposure dose (J/cm²) on the horizontal axis and the colloid absorbance (mm⁻¹) on the vertical axis. From the above plot, the slope at ultraviolet exposure dose of 1 J/cm² to 2 J/cm² (the slope of the straight line connecting a plot of the colloid absorbance at an ultraviolet exposure dose of 1 J/cm² and the plot of the colloid absorbance at an ultraviolet exposure dose of 2 J/cm²) and the slope at ultraviolet exposure dose of 0 J/cm² to 1 J/cm² (the slope of the straight line connecting a plot of the colloid absorbance at an ultraviolet exposure dose of 0 J/cm² and a plot of the colloid absorbance at an ultraviolet exposure dose of 1 J/cm²) were determined, and the this index was calculated for each example. The results are shown in Table 1.

(Slope at ultraviolet exposure dose of 1 J/cm² to 2 J/cm²)/(slope at ultraviolet exposure dose of 0 J/cm² to 1 J/cm²)

The “slope at ultraviolet exposure dose of 1 J/cm² to 2 J/cm²” means “(Abs2-Abs1)/(2 J/cm²-1 J/cm²)”, and the “slope at ultraviolet exposure dose of 0 J/cm² to 1 J/cm²” means “(Abs1-Abs0)/(1 J/cm²-0 J/cm²)”.

In addition, the above formulas, “Abs2” means the colloid absorbance at an ultraviolet exposure dose of 2 J/cm², “Abs1” means the colloid absorbance at an ultraviolet exposure dose of 1 J/cm², and “Abs0” means the colloid absorbance at an ultraviolet exposure dose of 0 J/cm².

FIG. 2 shows a graph in which data of photosensitive glasses in Example 1 and Example 2 are plotted on a coordinate system with an ultraviolet exposure dose (J/cm²) on a horizontal axis and a colloid absorbance (mm⁻¹) on a vertical axis.

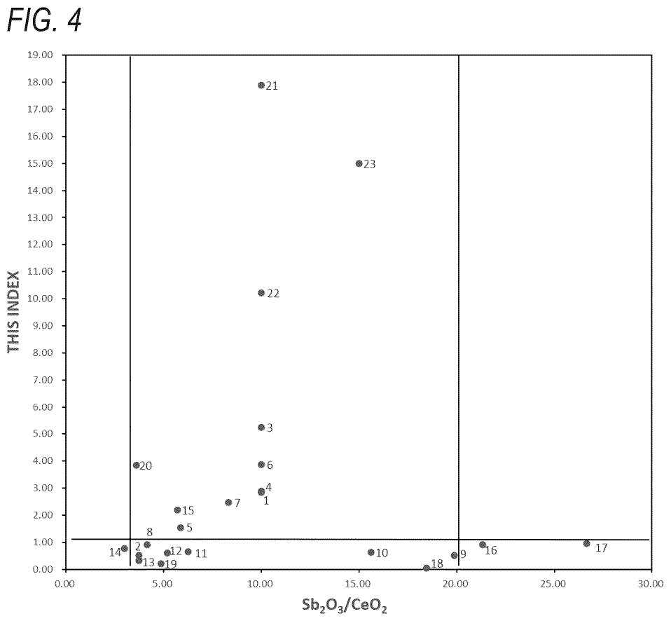

FIG. 4 shows a graph in which data of photosensitive glasses in Examples 1 to 23 are plotted on a coordinate system with Sb₂O₃/CeO₂ on a horizontal axis and this index on a vertical axis.

### Glass Transition Temperature Tg (° C.)

The Tg of the photosensitive glass in each example was determined according to the standard in JIS R3103-3 (2001) using Thermoplus EVO2TMA8311 manufactured by RIGAKU Corporation. The results are shown in Table 1.

TABLE 1

| | | | Slope at 0 J/cm² | Slope at 1 J/cm² | This |
|---|---|---|---|---|---|
| | Tg | Heat treatment | to 1 J/cm² | to 2 J/cm² | index |
| | (° C.) | (° C.) × (h) | — | — | — |
| Example 1 | 438.5 | 485° C. × 5 h | 0.162 | 0.459 | 2.84 |
| Example 2 | 436.2 | 485° C. × 5 h | 1.527 | 0.773 | 0.51 |
| Example 3 | 439 | 485° C. × 5 h | 0.124 | 0.652 | 5.25 |
| Example 4 | 438.5 | 485° C. × 5 h | 0.158 | 0.454 | 2.88 |
| Example 5 | 437.4 | 485° C. × 5 h | 0.986 | 1.519 | 1.54 |
| Example 6 | 437.1 | 485° C. × 5 h | 0.236 | 0.911 | 3.86 |
| Example 7 | 437 | 485° C. × 5 h | 0.434 | 1.069 | 2.46 |
| Example 8 | 437 | 485° C. × 5 h | 1.248 | 1.117 | 0.89 |
| Example 9 | 437.1 | 485° C. × 5 h | 0.857 | 0.442 | 0.52 |
| Example 10 | 435.6 | 485° C. × 5 h | 0.490 | 0.309 | 0.63 |
| Example 11 | 434.7 | 485° C. × 5 h | 0.845 | 0.551 | 0.65 |
| Example 12 | 434.5 | 485° C. × 5 h | 1.153 | 0.680 | 0.59 |
| Example 13 | 435.2 | 485° C. × 5 h | 2.062 | 0.652 | 0.32 |
| Example 14 | 437.2 | 485° C. × 5 h | 1.150 | 0.870 | 0.76 |
| Example 15 | 455 | 485° C. × 10 h | 0.114 | 0.248 | 2.18 |
| Example 16 | 436.1 | 485° C. × 5 h | 0.141 | 0.128 | 0.91 |
| Example 17 | 436.9 | 485° C. × 5 h | 0.093 | 0.088 | 0.95 |
| Example 18 | 450.9 | 500° C. × 1 h | 0.144 | 0.007 | 0.05 |
| Example 19 | 455.5 | 500° C. × 1 h | 0.070 | 0.014 | 0.21 |
| Example 20 | 456 | 510° C. × 5 h | 0.237 | 0.911 | 3.84 |
| Example 21 | 455 | 510° C. × 5 h | 0.009 | 0.161 | 17.89 |
| Example 22 | 445 | 485° C. × 5 h | 0.060 | 0.613 | 10.22 |
| Example 23 | 440 | 485° C. × 5 h | 0.006 | 0.090 | 15.00 |

| | SbO₂/CeO₂ | CeO₂ | Sb₂O₃ | Ag₂O | SiO₂ | Al₂O₃ | Li₂O | Na₂O | K₂O | B₂O₃ | ZnO |
|---|---|---|---|---|---|---|---|---|---|---|---|
| | — | Based on oxides (mo1%) | | | | | | | | | |
| Example 1 | 10.00 | 0.010 | 0.100 | 0.029 | 68.60 | 1.83 | 16.48 | 5.49 | 5.49 | 0.61 | 1.39 |
| Example 2 | 3.75 | 0.010 | 0.038 | 0.029 | 68.60 | 1.83 | 16.48 | 5.49 | 5.49 | 0.61 | 1.39 |
| Example 3 | 10.00 | 0.010 | 0.100 | 0.029 | 68.60 | 1.83 | 16.48 | 5.49 | 5.49 | 0.61 | 1.39 |
| Example 4 | 10.00 | 0.010 | 0.100 | 0.029 | 68.60 | 1.83 | 16.48 | 5.49 | 5.49 | 0.61 | 1.39 |
| Example 5 | 5.88 | 0.017 | 0.100 | 0.029 | 68.60 | 1.83 | 16.48 | 5.49 | 5.49 | 0.61 | 1.39 |
| Example 6 | 10.00 | 0.010 | 0.100 | 0.029 | 68.60 | 1.83 | 16.48 | 5.49 | 5.49 | 0.61 | 1.39 |
| Example 7 | 8.33 | 0.012 | 0.100 | 0.029 | 68.60 | 1.83 | 16.48 | 5.49 | 5.49 | 0.61 | 1.39 |
| Example 8 | 4.17 | 0.012 | 0.050 | 0.029 | 68.60 | 1.83 | 16.48 | 5.49 | 5.49 | 0.61 | 1.39 |
| Example 9 | 19.89 | 0.003 | 0.059 | 0.037 | 68.60 | 1.83 | 16.48 | 5.49 | 5.49 | 0.61 | 1.39 |
| Example 10 | 15.63 | 0.002 | 0.038 | 0.029 | 68.60 | 1.83 | 16.48 | 5.49 | 5.49 | 0.61 | 1.39 |
| Example 11 | 6.25 | 0.006 | 0.038 | 0.029 | 68.60 | 1.83 | 16.48 | 5.49 | 5.49 | 0.61 | 1.39 |
| Example 12 | 5.21 | 0.007 | 0.038 | 0.029 | 68.60 | 1.83 | 16.48 | 5.49 | 5.49 | 0.61 | 1.39 |
| Example 13 | 3.75 | 0.010 | 0.038 | 0.029 | 68.60 | 1.83 | 16.48 | 5.49 | 5.49 | 0.61 | 1.39 |
| Example 14 | 3.00 | 0.010 | 0.030 | 0.029 | 68.60 | 1.83 | 16.48 | 5.49 | 5.49 | 0.61 | 1.39 |
| Example 15 | 5.71 | 0.017 | 0.097 | 0.037 | 74.16 | 2.62 | 18.04 | 1.58 | 2.58 | 0.16 | 0.72 |
| Example 16 | 21.33 | 0.004 | 0.080 | 0.037 | 68.07 | 3.35 | 20.98 | 1.67 | 4.36 | 0.61 | 1.40 |
| Example 17 | 26.67 | 0.004 | 0.100 | 0.037 | 68.07 | 3.35 | 20.98 | 1.67 | 4.36 | 0.61 | 1.40 |
| Example 18 | 18.45 | 0.003 | 0.059 | 0.037 | 68.07 | 3.35 | 20.98 | 1.67 | 4.36 | 0.61 | 1.40 |
| Example 19 | 4.88 | 0.012 | 0.059 | 0.037 | 67.77 | 3.34 | 20.89 | 1.67 | 4.34 | 0.61 | 1.39 |
| Example 20 | 3.60 | 0.010 | 0.036 | 0.021 | 68.60 | 1.00 | 16.48 | 5.49 | 2.20 | 4.73 | 1.39 |
| Example 21 | 10.00 | 0.010 | 0.100 | 0.012 | 68.60 | 1.00 | 16.48 | 5.49 | 2.20 | 4.73 | 1.39 |
| Example 22 | 10.00 | 0.010 | 0.100 | 0.022 | 68.60 | 1.83 | 18.31 | 4.58 | 4.58 | 0.61 | 1.39 |
| Example 23 | 15.00 | 0.010 | 0.150 | 0.022 | 68.60 | 1.83 | 18.31 | 4.58 | 4.58 | 0.61 | 1.39 |

TABLE 2

| | wt_SiO₂ | wt_Al₂O₃ | wt_Li₂O | wt_Na₂O | wt_K₂O | wt_B₂O₃ | wt_ZnO | wt_Ag₂O | wt_CeO₂ | wt_Sb₂O₃ |
|---|---|---|---|---|---|---|---|---|---|---|
| | Based on oxides (mass %) | | | | | | | | | |
| Example 1 | 70.44 | 1.34 | 4.34 | 1.16 | 1.54 | 0.39 | 0.62 | 56.590 | 1.180 | 1.220 |
| Example 2 | 70.66 | 1.34 | 4.34 | 1.16 | 1.53 | 0.39 | 0.62 | 56.670 | 1.180 | 1.220 |
| Example 3 | 70.44 | 1.33 | 4.33 | 1.16 | 1.54 | 0.39 | 0.62 | 56.600 | 1.180 | 1.220 |
| Example 4 | 70.44 | 1.33 | 4.33 | 1.16 | 1.54 | 0.39 | 0.62 | 56.600 | 1.180 | 1.220 |
| Example 5 | 70.43 | 1.34 | 4.34 | 1.16 | 1.54 | 0.39 | 0.62 | 56.590 | 1.180 | 1.220 |
| Example 6 | 70.44 | 1.34 | 4.34 | 1.16 | 1.54 | 0.39 | 0.62 | 56.590 | 1.180 | 1.220 |
| Example 7 | 70.44 | 1.34 | 4.34 | 1.16 | 1.54 | 0.39 | 0.62 | 56.590 | 1.180 | 1.220 |
| Example 8 | 70.61 | 1.34 | 4.34 | 1.16 | 1.53 | 0.39 | 0.62 | 56.660 | 1.180 | 1.220 |
| Example 9 | 70.58 | 1.34 | 4.34 | 1.16 | 1.54 | 0.39 | 0.62 | 56.640 | 1.190 | 1.220 |
| Example | 70.67 | 1.34 | 4.34 | 1.16 | 1.54 | 0.39 | 0.62 | 56.660 | 1.190 | 1.220 |
| 10 | | | | | | | | | | |
| Example | 70.67 | 1.34 | 4.34 | 1.16 | 1.53 | 0.39 | 0.62 | 56.670 | 1.180 | 1.220 |
| 11 | | | | | | | | | | |
| Example | 70.67 | 1.34 | 4.34 | 1.16 | 1.53 | 0.39 | 0.62 | 56.670 | 1.180 | 1.220 |
| 12 | | | | | | | | | | |
| Example | 70.66 | 1.34 | 4.34 | 1.16 | 1.53 | 0.39 | 0.62 | 56.670 | 1.180 | 1.220 |
| 13 | | | | | | | | | | |
| Example | 70.69 | 1.34 | 4.34 | 1.16 | 1.53 | 0.39 | 0.62 | 56.680 | 1.180 | 1.220 |
| 14 | | | | | | | | | | |
| Example | 78.00 | 1.82 | 4.48 | 0.31 | 0.67 | 0.11 | 0.34 | 75.780 | 1.460 | 1.120 |
| 15 | | | | | | | | | | |
| Example | 70.98 | 2.34 | 5.57 | 0.35 | 1.14 | 0.36 | 0.65 | 64.840 | 1.900 | 1.510 |
| 16 | | | | | | | | | | |
| Example | 70.91 | 2.34 | 5.57 | 0.35 | 1.14 | 0.36 | 0.65 | 64.810 | 1.900 | 1.510 |
| 17 | | | | | | | | | | |
| Example | 71.06 | 2.34 | 5.57 | 0.35 | 1.14 | 0.36 | 0.65 | 64.870 | 1.900 | 1.510 |
| 18 | | | | | | | | | | |
| Example | 71.04 | 2.33 | 5.55 | 0.35 | 1.14 | 0.36 | 0.65 | 64.960 | 1.890 | 1.510 |
| 19 | | | | | | | | | | |
| Example | 72.02 | 1.78 | 8.60 | 5.95 | 3.62 | 5.75 | 1.98 | 0.085 | 0.030 | 0.183 |
| 20 | | | | | | | | | | |
| Example | 71.81 | 1.78 | 8.58 | 5.93 | 3.61 | 5.74 | 1.97 | 0.048 | 0.030 | 0.508 |
| 21 | | | | | | | | | | |
| Example | 71.53 | 3.24 | 9.49 | 4.93 | 7.49 | 0.74 | 1.96 | 0.088 | 0.030 | 0.506 |
| 22 | | | | | | | | | | |
| Example | 71.35 | 3.23 | 9.47 | 4.91 | 7.47 | 0.74 | 1.96 | 0.088 | 0.030 | 0.757 |
| 23 | | | | | | | | | | |

### Patterning Performance Test

### (Test Examples 1 to 5)

The photosensitive glass in each of Examples 1 to 4 was placed in close contact with a mask (thickness: 2.3 mm, a mask with a Cr film light-shielding layer formed on one surface of a quartz substrate) having a total of 100 holes (10 vertical rows×10 horizontal rows=100 holes) with 10 holes vertically and 10 holes horizontally, each having a hole diameter of 100 μm, disposed at an equal interval, followed by exposing to ultraviolet light having a wavelength of 300 nm to 330 nm using a mask aligner (ES20ag manufactured by Nanometric Technology Inc.) at the ultraviolet exposure dose shown in Table 3. The UV illuminance was measured by attaching an ultraviolet cumulative photometer (UIT-250 manufactured by Ushio Inc.) and a light receiver (UVD-S313 manufactured by Ushio Inc.). Thereafter, a heat treatment furnace (UTO-15CD, manufactured by Koyo Thermo Systems Co., Ltd.) was used to perform a heat treatment at 535° C. to 600° C. for 3 hours to 15 hours, thereby performing patterning.

Regarding crystals precipitated in the photosensitive glass, crystal precipitation diameters on a front side (exposed surface) and a back side (opposite side to the exposed surface) were measured using a laser microscope (VK-X3000 manufactured by Keyence Corporation) for a total of 9 crystals (3 vertical crystals×3 horizontal crystals) among a total of 100 patterns (10 vertical rows×10 horizontal rows). The average crystal precipitation diameter of the 9 crystals measured is shown in Table 3 below.

Further, FIG. 3 shows a microscope photograph of the surfaces of the photosensitive glasses after etching the glasses in Example 1 and Example 2 in which crystal had been precipitated.

TABLE 3

| | | | | Crystal precipitation diameter | | |
|---|---|---|---|---|---|---|
| | Photosensitive | This index | Exposure dose | Front side | Back side | Difference |
| | glass | — | (J/cm²) | (μm) | (μm) | (μm) |
| Test Example 1 | Example 1 | 2.84 | 4 | 99.67 | 102.62 | 2.95 |
| Test Example 2 | Example 2 | 0.51 | 1 | 100.4 | 106.67 | 6.27 |
| Test Example 3 | Example 2 | 0.51 | 4 | 105.43 | 119.24 | 13.81 |
| Test Example 4 | Example 3 | 5.25 | 4 | 99.92 | 103.9 | 3.98 |
| Test Example 5 | Example 4 | 2.88 | 4 | 100.3 | 101.2 | 0.9 |

As shown in Table 3, in the Test Example 1, 4, and 5 of patterning performance test for Examples 1, 3, and 4 as Working Examples, a difference in crystal precipitation diameter between the crystals generated on the front side and the back side of the photosensitive glass is small. In addition, as shown in FIG. 3, almost no pits are formed on the surface of the photosensitive glass after patterning. This indicates that the photosensitive glasses in Working Examples, in which this index is greater than 1.0, can prevent crystal precipitation caused by diffracted light and stray light during the exposure, and can be subjected to precise pattern processing.

In addition, as shown in Table 1 and FIG. 4, the photosensitive glasses in Working Examples, in which this index is greater than 1.0, have Sb₂O₃/CeO₂ in the range of 3.0 to 20 in terms of mol % based on oxides. This indicates that when the Sb₂O₃/CeO₂ is 3.0 or more, the Sb₂O₃ content relative to the CeO₂ content is sufficiently high, and a reaction under light at a low exposure is less likely to proceed; and that when the Sb₂O₃/CeO₂ is 20 or less, the content of Ce as an electron donor material is not too small, the colloid is likely to generate after an exposure and a heat treatment, and the Sb₂O₃ content relative to the CeO₂ content is not too large, so that a high exposure dose provides sufficient photosensitivity.

On the other hand, as shown in Table 3, in the Test Example 2 and 3 of the patterning performance test for Example 2 as a Comparative Example, the difference in crystal precipitation diameter between the crystals formed on the front side and the back side of the photosensitive glass is large. In addition, as shown in FIG. 3, many pits are formed on the surface of the photosensitive glass after patterning. This indicates that the photosensitive glass in Comparative Example, in which this index is 1.0 or less, cannot sufficiently prevent crystal precipitation caused by diffracted light and stray light during the exposure, and is difficult to be subjected to precise pattern processing

Although the present invention has been described in detail with reference to specific embodiments, it is apparent to those skilled in the art that various changes and modifications can be made without departing from the spirit and scope of the present invention. The present application is based on Japanese Patent Applications No. 2024-031547 filed on Mar. 1, 2024 and No. 2025-025261 filed on Feb. 19, 2025, and the contents thereof are incorporated herein by reference.

### REFERENCE SIGNS LIST

1: photosensitive glass
2: mask
3: light
4: openings
5: diffracted light
6: stray light

What is claimed is:

1. A photosensitive glass, wherein in a case where the photosensitive glass is irradiated with ultraviolet light having a wavelength of 300 nm to 330 nm, followed by subjecting to a heat treatment at a temperature in a range of (a glass transition temperature Tg+20° C.) to (a glass transition temperature Tg+65° C.) to generate a colloid, when an colloid absorbance at an ultraviolet exposure dose of 0 J/cm², 1 J/cm², and 2 J/cm² is plotted on a coordinate system with the ultraviolet exposure dose (J/cm²) on a horizontal axis and the colloid absorbance (mm⁻¹) on a vertical axis, (slope at ultraviolet exposure dose of 1 J/cm² to 2 J/cm²)/(slope at ultraviolet exposure dose of 0 J/cm² to 1 J/cm²) is greater than 1.0.

2. The photosensitive glass according to claim 1, wherein the slope at ultraviolet exposure dose of 0 J/cm² to 1 J/cm² is 0.001 to 1.0.

3. The photosensitive glass according to claim 1, having a ratio of a Sb₂O₃ content to a CeO₂ content, that is Sb₂O₃/CeO₂, of 3.0 to 20 in terms of mol % based on oxides.

4. The photosensitive glass according to claim 1, comprising: 0.01% to 0.3% of Sb₂O₃ in terms of mol % based on oxides.

5. The photosensitive glass according to claim 1, comprising: 0.002% to 0.04% of CeO₂ in terms of mol % based on oxides.

6. The photosensitive glass according to claim 1, comprising: B₂O₃.

7. The photosensitive glass according to claim 1, comprising, in terms of mol % based on oxides, 59.0% to 81.0% of SiO₂, 8.0% to 26.0% of Li₂O, 1.0% to 10.0% of Na₂O, 1.0% to 10.0% of K₂O, 0% to 5.0% of Al₂O₃, 0% to 6.0% of ZnO, and 0% to 8.0% of B₂O₃.

8. The photosensitive glass according to claim 1, comprising: 0.01% to 1.0% of Ag₂O in terms of mol % based on oxides.

9. The photosensitive glass according to claim 1, comprising: an ultraviolet absorbing component.
